(19) United States
(12) Patent Application Publication
(10) Pub. No.: US 2010/0220434 A1
(43) Pub. Date: Sep. 2, 2010

(54) Bag computer

(76) Inventor: Charles A. Daley, III, Rawai (TH)

Correspondence Address: Charles A. Daley III, P.O. Box 184, Karon PO, T. Karon, A. Muang, Phuket, 83100, TH

(21) Appl. No.: 12/584,304

(22) Filed: Sep. 4, 2009

Related U.S. Application Data
(62) Division of application No. 11/796,920, filed on May 1, 2007, now abandoned.
(60) Provisional application No. 60/830,300, filed on Jul. 12, 2006.

(51) Int. Cl. G06F 1/16

(52) U.S. Cl. 361/679.27

(57) ABSTRACT

The bag computer is a computer/bag combination or computer made to mount on a bag so the display can pivot into the line of sight of the operator. Several embodiments include: A computer with the pivoting display near the bag's front top and a keyboard near the front bottom. The keyboard may pivot and there may be a pointing device on the display back: A two panel computer pivotally held to the bag front: a computer/bag combination with a display pivotally attached to the bag front. Other computer embodiments illustrating various computer mounting means including: Inside and outside computer parts attached through the bag front; Fasteners positioned on the computer body's display side or projecting from the computer body's back: A mounting flange around the computer body perimeter. Two hanger bars or two attachments on the right and left sides of the computer body front.

### CROSS-REFERENCE TO RELATED APPLICATIONS

This application is a divisional application of copending patent application Ser. No. 11/796,920, filed on May 1, 2007, which claims priority from U.S. provisional patent application Ser. No. 60/830,300 filed Aug. 12, 2006, the disclosure of which are incorporated herein by reference.

### TECHNICAL FIELD

The present invention relates to a mobile computer meant to be operated while mounted on a computer bag.

### BACKGROUND OF THE INVENTION

Computers are becoming an essential part of people's lives. Most people are introduced to computer via the “desk top” computer and spend most of their computing time on one of these machines. The desktop computer is too large to be easily moved so the computer industry responded with the lap top (notebook) computer, portable tablets, “palm tops”, and various hand held devices. The lap top, despite its name, is normally used on a desk and is simply a portable desk top machine. Hand held devices and palm tops, because of their size, cannot be viewed as easily as a desktop, do not have keyboards with standard keys for two hand typing, cannot operate with conventional software, cannot incorporate normal peripherals and, because of their size, must have inferior memory, speed, batteries and telecommunications components.

Tablet computers can be mounted inside special open front bags so they can be quickly accessed. However, they do not have keyboards, present a format different from familiar desk top computers and must be lifted and held in that position for use. Because they must be lifted, the bag that holds them is not suitable for carrying additional general cargo or computer equipment. Holding also implies disabling the hands.

The objective of the current invention, then, is to produce a mobile computer that can be used at any time and position while still performing as closely as possible to a standard desk top computer. The bag computer combines a computer with a bag to: view the fold out display without lifting the machine; type with two hands because the bag's strap holds the machine; allow storage of general cargo or additional computer equipment inside the bag; be more comfortable to carry because it is softer and forms to the body better than a hard computer body; protect the computer from falling while in use; allow renewing of the visible and less expensive bag portion; allow the operator to chose a bag style of his liking. The advantage of the bag computer can be optimized by making a computer specialized for bag mounting.

Two patent applications (June 2006 publication numbers 20060113203 and 20060113213) deal with a bag meant to hold a computer on the inside or outside of a bags front wall. The design of computers specifically meant to be mounted on a bag's front wall and operated from the exterior of the bag has not been an active field of invention. However, there are some portable computers which have some of their characteristics and comment will be made on these.

Embodiment A1. Bag mounted computers can be as big as a lap top but optimally they would be somewhat smaller. With display size of about 10″ diagonal, the display should be as close to the operator as possible. This can be done by hinging the display near the top of the bag with the display facing out so that when it pivots up it is perpendicular to the operator's line of sight. The keyboard, though, would optimally be located lower on the bag front with the operator's arms in a relaxed position to the sides of the display with hands on the keyboard. Thus, the display is between the operator and the keyboard. The keyboard may be retractable.

Japanese utility model laying-open No. 62-201826 (FIG. 7 in U.S. Pat. No. 5,034,858)_has three pieces (display, computer body and keyboard) with the keyboard storing between the display and the center section. However, the keyboard is oriented in the wrong direction and the display is on the wrong side of its panel. Thus, it is meant to be operated with the keyboard and computer between the operator and the display.

Japanese utility model laying-open No. 60-148632 (FIGS. 3 and 4 in U.S. Pat. No. 5,034,858) and U.S. Pat. No. 5,247,285 are desk tops meant to be used vertically and have the displays on the outside of their display panels. They have a keyboard which removably stored on the front of the computer. A keyboard that must be removed for use is a liability in the mobile environment. They are meant to be used on a desk with the keyboard setting on the desk between the operator and the rest of the computer. In this position, the keyboard would be facing the wrong direction for an A1 bag mounted computer. These computers may also be compared to model A1a, the pocket mounted two panel version of the bag computer with the display facing out and the keyboard mounted separately on a cover flap. The resemblance is even closer here but in 60-148632 and U.S. Pat. No. 5,247,285 the base is meant to stand the computer vertically on a desk top and the holder for the keyboard makes it virtually impossible to be mounted on the front of a bag. The bag mounted computer could not stand alone on a desk top. Also, the desk top computer would have its display picture upside down. The computer shown in U.S. Pat. No. D317,443 may be mountable in a pocket with an opening in the front but the display in this invention cannot be opened so that the display is near the top of the bag with the display facing the operator. It also has an integral keyboard.

U.S. Pat. Nos. 5,548,478 and D427,160 are about a “lap top” computer with a display which slides toward and away from the operator on channels on either side of the computer body. If the display is slid all the way forward, it resembles the A1 style. However, the objective of these patents is the sliding display not the positioning of the keyboard in a lower, more convenient situation for typing on the front of a bag. There is no space between the display and keyboard to allow the hands to comfortably reach the keyboard when the display is “forward”. As configured, the display cannot be closed with the display in the forward position. Its complexity would be a liability in the mobile environment.

Because it is desirable to make the keyboard and display the same size and because there is no need for a touchpad on the keyboard panel, a compact keyboard may be used. This keyboard would be 10 keys wide, 3 or 4 rows and with thumb keys to actuate keys farther to the right and left (e.g. shift and backspace). There may be tactile finger references such as vertical finger, thumb or edge guides.

Most keyboards have tactile references such as the small bumps on the “F” and “J” keys of the standard QWERTY keyboard. One patented keyboard (U.S. Pat. Nos. 4,449,839, 4,778,295) has troughs for keys. 20020097227 is a keyboard ten keys wide with one row and thumb keys to designate other needed rows. Although it is compact, the letter keys are not “normal”, a crucial need for typing with two hands.

A keyboard with the keys “a” to “;” wide and thumb keys for keys farther to the sides was disclosed as part of a wearable computer in U.S. Pat. No. 6,167,413. There were no details. U.S. Pat. No. 4,847,799 also used thumb keys.

Several keyboards may be programmable to adapt to different programming and operator preference (U.S. Pat. Nos. 4,633,227, 4,847,799).

A1a embodiments. The A1 model may have a keyboard which would be pivotally mounted on the bag front. The computer part, then, has two panels (body and display) hinged together with the display facing out. This is the A1 a model series. They variously have couplings to match bag mounting and pointing devices suited to bag use.

Most of these computers also require clearance between the body and display panel for the material of the bag front of pocket. Japanese utility model laying-open No. 62-201826 has a large, specially shaped gap between the display and computer in order to store its removable keyboard. This model has its display facing in rather than out, though.

U.S. Pat. No. 5,034,858 is a computer meant to be used on a desk and primarily describes a hinged swiveling display attached to a flat computer body. It is not intended to be used vertically on a bag front. It does have a gap between the display and computer body to store a keyboard. But the display faces in when stored and must be swiveled 180 degrees each time it is opened for use. It has no accommodation for a bags mounting structure such as a computer/bag coupling, body shaping, matching attachments, etc. U.S. Pat. No. D330,197 is a two panel computer with its display facing out. Its keyboard stores in a special chamber between the two panels. This is a desk top machine, there is no clearance for the material of a bag's front wall or a pocket and there is no accommodation for a bags mounting structure. Neither of these computer have accommodation for a built in pointing device.

U.S. Pat. No. 4,624,434 (1986) shows a two panel unit with the display facing out with a hinge between the panels that can hold the display in a variety of angles.

U.S. Pat. No. 6,006,243 (called “trifold” computer)_is a computer with three pieces (display, display holder and keyboard/computer (in that order)). Although the display may be seen as oriented in the right direction, the keyboard is facing the wrong direction and is laden with computer equipment. The display holder is not built to attach the computer to a vertical surface. Also, the display is stored between the keyboard/computer and the display holder and cannot be opened before the keyboard. It is not meant to be mounted on a vertical surface or used without a desk.

U.S. Pat. No. 6,556,430, shows a normal lap top with a keyboard that slides into the middle section. This is one method of retracting the keyboard but the display is on the wrong side of the display panel and the keyboard is facing the wrong direction.

U.S. Pat. No. 6,700,773. This has 3 panels with displays on #1 and #3 and has hinges capable of 360 pivoting with the displays storing on opposite sides of the computer body. The keyboard is on the center section with the main computer equipment. The purpose of this computer is to have a portable desk used computer with 2 displays for touch screen drawing and viewing. The problem is 1) there is no provision and it is nearly impossible to make provision for mounting this computer on a bag front or flap on the bag front, 2) the second display cannot be folded into storing position if mounted on a bag. 3) both displays cannot be folded down over the KB at the same time, 4) it is unnecessarily complicated.

The A1 style computer with the separate keyboard (A1a) has some similarities to small portable CD/DVD players with displays now on the market. The display is on the wrong side of the display panel, though, and these machines lack the computer, keyboard and touchpad components.

U.S. Pat. No. 5,416,310 disclosed is a pocket mounted computer with an extension of the body beyond the display all around to keep the computer from falling out of a pocket with an opening in front. The display faces the wrong way.

A2 embodiment. Some two panel computer have attachments on the keyboard edge opposite the display hinge edge but these are not meant to pivotally attach and support the computer to a vertical bag surface. For example, U.S. Pat. No. 6,820,138 has attachments on this edge for removable securing a storage module. U.S. Pat. Nos. 6,421,235 and 5,861,873 also have attachments on this edge but the purpose here is to removably secure a communications module.

Another objective of this embodiment, to pivot the display at least 270 degrees relative to the body panel for improved viewing and typing on a bag front, can be done with a single axle hinge and cutouts on the display and/or body panels. There are lap top style computer with hinges that swing greater than 270 degrees. U.S. Pat. No. 5,594,619, for example, has a hinge that swings 360 degrees for the purpose of changing its configuration from a lap top to a tablet computer. However, it is meant to be used on a table and the hinge has two axles and is more complicated than needed. The computer is too heavy for hinging on the front of a bag. U.S. Pat. No. 6,757,157 is a hand held computer with a 360 degree hinge between the body and display. This computer also uses a double axle hinge to enable the 360 pivoting.

There are also mini-notebook (palm top) computers designed to open and lock at 180 degrees (U.S. Pat. No. 5,914,853).

U.S. Pat. No. 4,624,434 (1986) shows a two panel unit with the display facing out with a hinge between the panels that can hold the display in a variety of angles.

Other computers with 3 hinged panels include U.S. Pat. No. 6,006,243 and U.S. Pat. No. 6,700,773 (see above) but these are different in arrangement and usage.

A3 embodiment. This embodiment deals with a two panel bag computer with computer panel hinged to an input/output panel having a display on one side and a touchpad on the other and these are fused together as one unit. The input/output panel cannot function alone as an independent computer. In the bag computer environment, this provides for a light thin display panel, the part that is moved and handled, and allows the operator to view the display and use the touchpad in “book reading” position. Other computing equipments is stationary on/in the bag. There may be removable tactile finger guides over the touchpad.

There are computers with hinged display panels and various controls on the display side of the display panel (e.g. backlight control, track ball). One of these includes clickers on the opposite side of the display panel; the purpose here is one hand “mouse” use on a palm top (U.S. Pat. No. 5,208,736). The Nokia 9300 is a two panel palm top/telephone with controls and displays (but no touchpad) on both sides of one panel. There is further computer equipment between the two sides of this panel.

There is a patent for a “card” with a display on one side, touchpad on the other and the computing equipment sandwiched between (U.S. Pat. No. 5,543,588). Application 2006092137 is a hand held with a touchpad on the back and may have a plurality of touch areas. Single panel computers must have thicker, heavier and more complicated display/computer panel for a given amount of computing power, a disadvantage for handling on a bag front.

The backside keyboard, 20040208681, is a single panel computer and has a display (and some keys) on the front side with a split (right and left) keyboard on the back. It is operated by holding the computer with two hands and fingering keys on the side of the computer away from the operator. 20030193477 is similar and can have a “mouse” is an option for the back. The target of these patents is keys and there is additional computing equipment between the front and back sides of the machine.

U.S. Pat. Nos. 6,392,637 and 6,507,338 deal with adjoining touch pads with finger guides meant for mounting on the keyboard panel of a standard lap top computer. No display is involved.

A6 embodiment. This is a combination of a bag and pivoting display on the bag front. Patent applications 20060113203 and 20060113213 are bags meant to have a computer with pivoting display mounted to their front walls thus forming the A6 embodiment.

A6a embodiment. Most small single panel computers are meant for hand use and have no attachments. Portable bicycle computers (e.g. U.S. Pat. Nos. D342,211, D342,034, D34,897) and some handheld computer can be mounted in special brackets or docking ports fitted to the computer body. These are not well adapted to pivotally mounting on a bag front. They are not shaped properly for a bag front, do not have their attachments positioned correctly, the docking ports they must use are bulky and often not strong enough and their mounts cannot compensate for bag bulge caused by cargo load.

A7 embodiment. This is a computer panel with a keyboard on one side and a touchpad on the other. The display is a separate head mounted display (HMD). It has attachments to pivotally mount it to a bag front.

There are wearable computers that use head mounted displays. U.S. Pat. No. 6,176,413, for example, uses a shoulder strap supported computer in conjunction with a HMD. Other wearables use vests or belts to hold the computer associated with the HMD. The do not appear to be normal apparel, essentially change the appearance of the operator wearing them and do not have the second purpose of carrying general cargo. A computer panel pivotally attached to a bag front with both the pointing device and keyboard would be an improvement over these devices.

B2 embodiment. This is a technique to mount a two panel computer to a bag front. It splits the computer into inside and outside parts and connects them with attachments through the bag front with allowance for the bag's front wall material. The art of attaching computer to bag fronts is not well explored by inventors.

Many computers have been pictured permanently attached to horizontal surfaces. Horizontal surfaces, such as a table or the inside of a case, are not active parts of the computer and are not considered two (or more) essential parts of one computer.

Many lap top computers have recessed fixtures on their bottom sides or edges to removably couple with docking ports. Docking ports are normally designed to connect the computer to other computers, power and telecommunications and aren't usually considered “mobile”. Docking ports usually cradle the computer they couple with and mold also to the side edges.

Docking ports do not provide for the allowance needed for the thickness of bag front material as needed with computer parts attaching together through a bag front.

There are removable keyboards (U.S. Pat. Nos. 6,421,235, 6,820,138, D470,781) but none are meant to mount on a bag front, with clearance for bag material or by the VBN edge of the keyboard.

There are several patents for removable displays. Some are the display alone and some are for a display with a hinge (U.S. Pat. Nos. 4,749,364, 5,724,704, 6,201,688, 5,193,069). None are meant to mount on a bag front, with clearance for bag material.

There are patents for modularized computers designed to mount components in them (e.g. U.S. Pat. Nos. 5,861,873, D370,006, standard tower computer). None of these fit the description of a computer meant to mount on a bag front by coupling through the bags front wall.

B4 embodiment. This technique to mount a two panel computer to a bag front uses attachments on the same side of the computer as the display (the “up” side on a lap top). This allows attachment to the bag front by the display side (e.g. on the inside bag wall surface with an opening for use).

There are computer patents referring to attachment of the computer to a table, base or docking port. Some attachments on the bottom side of notebook computers are coupled with detailed and mechanical locks for docking ports (e.g. U.S. Pat. No. 6,898,079). None, though, have attachments on the “up” side of the computer body (the same side as the display).

Some portable computers have extensions of their bodies beyond the display where attachment could be (but aren't) mounted. For example, wearable vest/computer U.S. Pat. No. 5,416,310 shows a vest with computer equipment in pockets and discloses a two panel computer with an extension of the body beyond the display panel. It is primarily meant for pocket mounting but attachments are claimed for the side of the computer opposite the display (the back). A computer of this sort was pictured in application 20060113213 in support of the bag used to hold it.

B5 embodiment. As noted in B4, there are computers meant to be mounted on surfaces by their bottom sides (side opposite the display). However, because these computers are also meant to set flat on a table, the attachments are never part of and projecting out from the bottom side of the computer. Some portable computer carriers (e.g. U.S. Pat. No. 6,763,942) will hold a computer in a vertical position but they use standard notebook computers and depend on securing the edges of plain computer housings.

B6 embodiment. This two panel computer uses a flange around its body perimeter to couple the computer with the bag. Computing equipment made for mounting on racks may have or may be mounted to flanges. Some car video equipment mounts to openings in interior walls or roof and requires flanges. These, however, are not self-contained, are not computers and do not have a keyboard or pointing device. There are computers with extensions of their bodies beyond the display for the purpose of ornamentation (U.S. Pat. Nos. D455,743, D392,625) or vest mounting (U.S. Pat. No. 5,416,310) but these are not efficient for mounting a computer to an opening in a rigid front bag.

B7 embodiment. This two panel computer uses two hangers to attach the computer to the bag front. Hangers are common for portable electronic equipment. Examples include the belt clip on a walkman music player and the belt clip on some hand held equipment (calculator, PDA, etc). A computer mounted to a bag front is wider, though, so that a single hanger is not adequate. For easy mounting, normal hangers usually project out from the equipment body. Removable hangers on electrical equipments also project from the equipment body. A computer on a bag front must be flush with the bag front when mounted.

### BRIEF SUMMARY OF THE INVENTION

These embodiments of the present invention solve the problems and address the drawbacks of the approaches in the above description. They serve to combine a computer with a bag so that input/output devices are accessible on the front of the bag without need to open the bag or remove equipment. The operator can use the computer with two hands without need to support it manually.

A1. This embodiment of the bag computer places a display panel with the display facing out on a hinge near the top (operator end) of the computer body. The keyboard is lower down on the front of the computer. When mounted on a bag front, the display pivots out into the line of sight of the operator and as close as possible. The keyboard is operated with the hands on the far side of the display with the arms to the sides of the display. The keyboard may be retractable under/over the display panel. It can be mounted on the outside or inside of the bag. The display and keyboard may be removable for easy installation. If mounted inside the bag, there may be peripheral mount on the computer back and speakers facing up toward the operator. There may be a pointing device on the display back for use with hands in “book reading” position.

A1a1. This embodiment works the same way as A1 but the keyboard is mounted separately. The computer has a display panel and a body panel with a complimentary support structure to match the bag and secure it in place. When mounted inside the bag, there is an opening in the front or top bag walls which allows the display to remain outside the bag for viewing. There is space between the two computer panels to allow them to close with the bag material between. There may be a pointing device on the display back and computer equipment mounts on the computer body back.

A1a2. This embodiment is like A1a1 but it is meant to mount on the outside of the bag front in a holster. It is shaped to fit the holster, has a hinge to compensate for holster material thickness and may have a pointing device on the display back.

A1a3. This embodiment is like A1a2 but the pointing device is mounted on the body under the display panel so it can be used with a holster mount with an operating hole in the holster.

A1a4. This embodiment is also like A1a2 but has mounts meant to match a bag docking port. It may have the pointing device either on the display back or on the body under the display.

A1a5. This embodiment is also like A1a2 but has a display panel smaller than the computer body. The rim formed by the body retains the computer in a holster with an opening through which the display panel can be opened. Like others in the A1a series, the display faces out when shut.

A1b. This embodiment is the A1 style computer including the bag. The computer parts are removable and are specifically fitted to the bag. There may be electrical connection from the outside to inside the bag along with a mounting structure inside for further electrical equipment. The keyboard may pivot and the display panel may have a pointing device on its backside.

A2. The A2 embodiment computer has a display panel and body panel hinged together like a basic lap top. On the body edge opposite the display to body hinge edge there is an attachment to pivotally secure the computer to the bag front. The display to body hinge may have a single axle hinge and cut outs on either or both of the panels to allow the panels to pivot at least 270 degrees. This combination of hinging allows the computer's display to be positioned either 1) low on the bag like a lap top for normal typing or 2) high on the bag with the display as close as possible to the operator. There may be a pointing device on the display panel back. There may also be a third panel with more computing power which may be removable attached to the keyboard panel. This panel may be inside the bag, may have peripheral mounts on the back and may have speakers facing up toward the operator.

A2a. This embodiment is the A2 style computer including the bag. The computer parts are removable and are specifically fitted to the bag. There may be electrical connection from the outside to inside the bag along with a mounting structure for further electrical equipment. The display panel may have a pointing device on its backside.

A3. This computer meant for bag mounting has a computer body panel hinged to an input/output panel with a display on one side and a touchpad on the other. The input/output panel may be of three layered construction with a rigid clear support layer with a display array and touchpad layers fused to it. There is electrical connection through the hinge to the body panel where the computing equipment is. There may be removable finger guide templates for the touchpad. A compact, tactile keyboard with standard size keys (10 keys wide with thumb keys) may be provided to match the small computer size.

A6. This bag computer is a bag with a computer unit and a pivoting display panel on the front wall. The computer and display may be removably secured to the bag and there may be an electrical connection from the display panel through the bag's front wall to the interior of the bag where there may be mounts for further computer equipment or peripherals. The display may have a pointing device on the back.

A6a. This embodiment of the bag computer is a single panel computer with a display and an attachment on the edge nearest the bottom of the display to match and pivotally secure it to the bag front. The attachments may be one or more plug-in clips, lateral mount channels, half hinges or other means.

A7. This embodiment is for use with a head mounted display (HMD). The computer has a keyboard on one side, a pointing device on the other and pivotally mounts to the bag via its edge or back. It may have a second computing panel hinged to the first for more power.

B2. This embodiment demonstrates how a two panel bag computer can be mounted to a bag front. The computer is in two or more parts with part inside the bag and part outside the bag. Attachments hold them together with the bag's front wall between with allowance for bag thickness and fixtures. There may be peripheral mounts on the back of the inside part, speakers facing up toward the operator and a bag to match.

B4. This embodiment illustrates the mounting of a two panel computer to a bag using attachments on the same side of the computer body as the display. The attachments may be found under the display or on extensions of the computer body beyond the display panel. This allows the computer to be mounted to the inside of the bag's front wall so that the display can be opened through a bag front opening. It also allows outside mounting where the attachments should be in front for quick mounting and dismounting.

B5. This embodiment show how a two panel computer can be mounted to a bag front using attachments projecting out front the computer body back. They mount into the front of a matching bag.

B6. This embodiment allows a two panel computer to be mounted to an opening in a rigid front bag. It has a flange around the perimeter of the computer body. If the bag does not have attachments, they may be included on the computer.

B7. This embodiment shows that a two panel computer can also be hung on a bag front. To make sure the computer does not twist and is flush with the bag front, there are two built-in hanger bars or channels, right and left, which are placed either on the computer sides or inset in the computer back. There may be an electrical connection on the bag front which leads through the front wall to the interior.

Other aspects of the present invention will become apparent from the following detailed description, taken in conjunction with the accompanying drawings, which illustrate, by way of example, the principles of the invention.

### BRIEF DESCRIPTION OF THE SEVERAL VIEWS OF THE DRAWING

FIG. 1A shows the bag computer carried by a manikin in the stored position.

FIG. 1B shows the bag computer carried and operated by a manikin in the typing position.

FIG. 1C shows the bag computer carried and operated by a manikin by manipulating a pointing device on the display back.

FIG. 2A is a view of the A1 embodiment bag computer aligned for mounting on a bag front and with the display panel closed.

FIG. 2B shows the A1 embodiment bag computer with the display panel open for viewing.

FIG. 3A is a view of the A1 embodiment bag computer with a retractable keyboard using a pivoting retraction mechanism.

FIG. 3B is a view of the A1 embodiment bag computer with a retractable keyboard using a parallel arm swinging retraction mechanism.

FIG. 3C is a view of the A1 embodiment bag computer with a retractable keyboard using a sliding channel retraction mechanism.

FIG. 4 shows the compact “bag computer” style keyboard with, ten keys wide with thumb keys replacing the keys further to the right and left.

FIG. 5A is an exploded view of the A1 embodiment bag computer designed for mounting on the inside for the bag's front wall. The display and keyboard panels are removable.

FIG. 5B shows peripheral mounts on the back side of the A1 embodiment bag computer body for inside mounting.

FIG. 6A illustrates the A1a bag computer mounted on a bag and in the closed position.

FIG. 6B illustrates the A1a bag computer mounted on a bag and in the operating position.

FIG. 7A is an exploded view of the A1a inside mounted bag computer and how it matches the bag's mounts.

FIG. 7B is an exploded view of the A1a inside mounted bag computer and how it matches the bag's mounts as seen from the back side.

FIG. 8 shows the A1a outside mounted bag computer as it matches the bag's holster.

FIG. 9 shows the A1a outside mounted bag computer as it matches the bag's docking port.

FIG. 10 is the A1a inside mounted bag computer as designed for mounting through the bag's top wall.

FIG. 11 is the A1a outside mounted bag computer as designed for mounting in a holster.

FIG. 12 is the A1 a outside mounted bag computer as designed for mounting in a pocket with an operating opening. The display remains on the outside of the pocket.

FIG. 13 is the A1a outside mounted bag computer as designed for mounting in a docking port.

FIG. 14 is the A1a outside mounted bag computer as designed for mounting in a pocket with an operating opening. The both the body and display mount inside the pocket.

FIG. 15A shows the A2 bag computer with bag and in the stored position.

FIG. 15B shows the A2 bag computer with bag and with the cover flap open.

FIG. 15C shows the A2 bag computer with bag and with the display open in the “up” close view operating position.

FIG. 15D shows the A2 bag computer with bag and with the display and keyboard in the “down” typing operating position.

FIG. 16A shows the A2 bag computer ready for mounting near the top of the bag's front wall.

FIG. 16B shows a magnified view of the axle half hinge attachment on the attachment edge of the A2 bag computer.

FIG. 17A shows the A2 bag computer ready for mounting near the center of the bag's front wall.

FIG. 17B shows a magnified view of the channel attachment on the attachment edge of the A2 bag computer.

FIG. 18 is a view of the A3 embodiment bag computer aligned for mounting on a bag front, with the display panel closed and with the back side touchpad visible.

FIG. 19A is a view of the A3 embodiment bag computer with the display panel open.

FIG. 19B is a magnified view of the layered construction of the display panel of the A3 bag computer.

FIG. 20A shows the A6 bag computer in the stored position.

FIG. 20B shows the A6 bag computer with the cover flap open and the removable display ready for installation.

FIG. 20C shows a magnified view of the channel attachment between the display and bag of the A6 bag computer.

FIG. 20D shows the A6 bag computer in the operating position.

FIG. 21A is a view of the A6a bag computer ready for mounting on a bag with half hinge attachments.

FIG. 21B is a magnified view of the half hinge axle attachment of the A6a bag computer.

FIG. 22A is a view of the A6a bag computer ready for mounting on a bag with post and clip attachments (side release buckles)

FIG. 22B is a magnified view of the bag's pivoting post and clip attachments (side release buckles) designed to match the A6a bag computer's attachments.

FIG. 23A is a view showing the underside of the A6a bag computer and its attachments.

FIG. 23B is a magnified view of the post and clip (side release buckle) attachments on the A6a bag computer.

FIG. 24 is a view of the three axis of shaping to best fit the A6a bag computer to a bag front.

FIG. 25 is an exploded view of the A7 bag computer with an inside computing unit.

FIG. 26 is a view of the pointing device on the side of the A7 computer control panel opposite the keyboard.

FIG. 27 is an exploded view of a B2 bag computer mounted to a bag front with inside and outside parts plugged together.

FIG. 28 shows the plug mechanisms on the reverse side of the outside part of a B2 bag computer.

FIG. 29A shows the outside part of the B2 computer with the display open.

FIG. 29B shows the outside part of the B2 computer with the display and keyboard open.

FIG. 30 is a view of the outside mounted B4 bag computer ready for mounting on a bag front.

FIG. 31 is a view of the B4 bag computer with attachment on the same side of the body as the display panel.

FIG. 32 is an exploded view of the inside mounted B4 bag computer with attachments on the same side of the body as the display panel and matching the bag's mounting structure.

FIG. 33 is a view of the inside of the bag's front wall and the coupling which matches the B4 bag computer.

FIG. 34 shows a B5 bag computer ready for mounting in a bag opening with a rigid rim.

FIG. 35 shows the back side of the B5 bag computer with attachment projecting out from the body and matching the bag's opening.

FIG. 36 shows a B5 bag computer ready for mounting in a bag with a pattern of mounting holes.

FIG. 37 shows the back side of the B5 bag computer with attachment projecting out from the body and matching the bag's pattern of holes.

FIG. 38 is a view of the B6 bag computer with flange ready for mounting in an opening in the bag's front wall.

FIG. 39 is a view of the back side of the B6 bag computer showing attachments and peripheral connections.

FIG. 40 is a view of the B6 bag computer with the display panel open.

FIG. 41 shows a B7 bag computer with side hanger bars ready for mounting in complimentary fitting on a bag front.

FIG. 42 shows the back side of the B7 bag computer with side hanger bars.

FIG. 43 shows a B7 bag computer with inset back side hanger bars ready for mounting in complimentary fitting on a bag front.

FIG. 44 shows the back side of the B7 bag computer with inset back side hanger bars

### DETAILED DESCRIPTION OF THE INVENTION

There are characteristics which may be found in any bag computer embodiment. Bag computers are mobile, self contained units meant to be mounted and operated on the front wall of special computer bags. On the distal end of the display panel there may be a camera or an IR antenna for external communication. There may be speakers and sound openings in the side of the computer body facing up toward the operator. These openings may also be used for heat dissipation and the openings may lead to internal channels used to carry heat up and away form electrical equipment in the computer body. As with most portable computers, they may have telecommunications, GPS, MP3, infrared communication equipment, miscellaneous controls and batteries in addition to the computing equipment. Although they are specifically meant for shoulder bag mounting, they may also be suitable for waist mounting on a “belly bag” or mounting on a backpack.

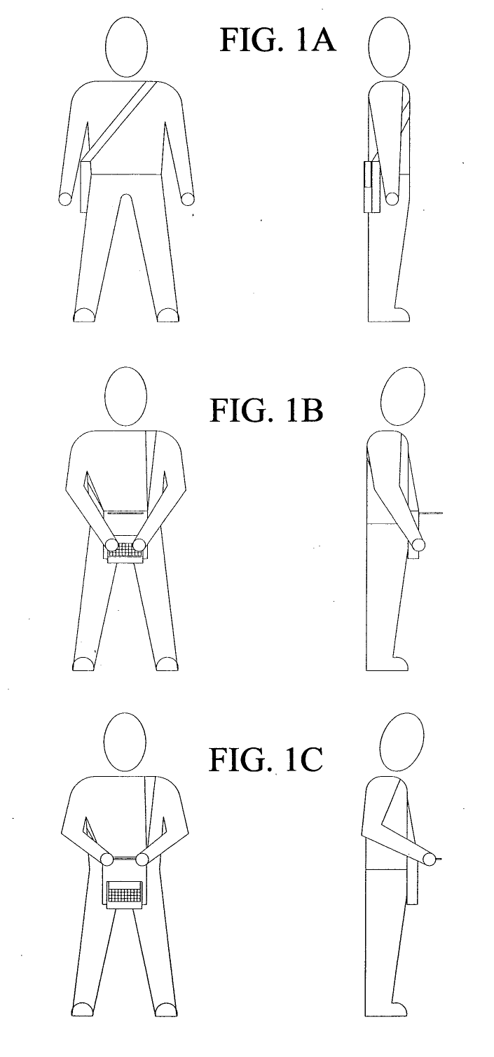

Embodiment A1. FIG. 1A to 1C show the operating position of the bag computer. Bag computers are meant to have I/O components such as display, pointing device and keyboard mounted on the outside of the front surface of a shoulder bag so it can be carried in a stored position 1A as a normal bag or operated with two hands while hanging in front of the operator. With this type of computer the display is usually compact but its apparent size can be maximized by positioning the display near the bag to as close as possible to the operator as in 1C. The keyboard, however, is best operated if it is positioned farther away where the hands and arms are in a relaxed position as in 1B. If a hinged display is located near the top of the bag front and the keyboard is located near the bottom, both optimal display and keyboard positions can be achieved.

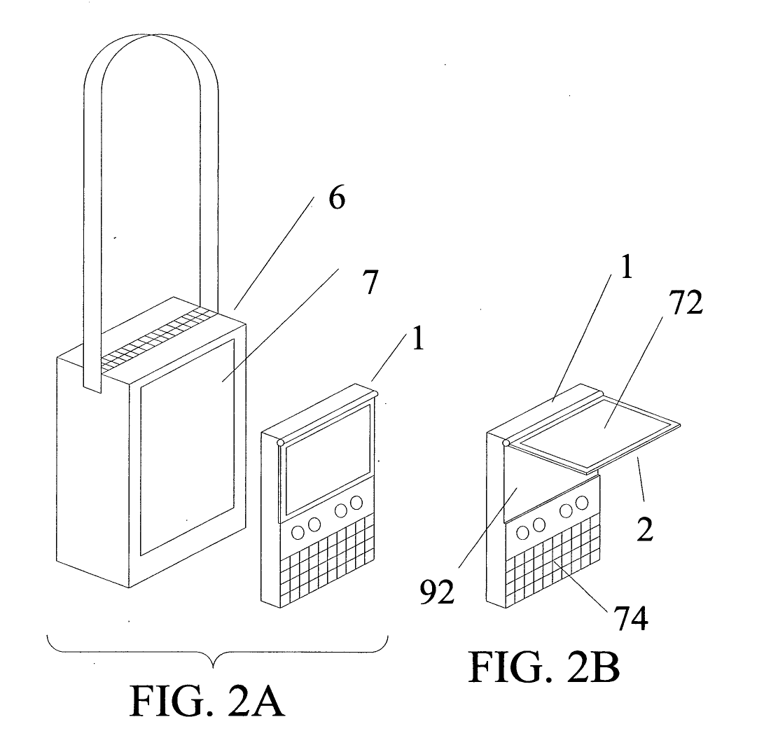

FIG. 2A shows one configuration of a computer adapted for mounting to a bag 6 via a mounting structure on the bag's front wall 7. As show in FIG. 2B the computer has a body panel 1 with a display panel 2 which is pivotally mounted to the body. The display panel can pivot flat against the computer body when closed or be opened to approximately perpendicular to the operator's line of sight. The display 72 faces away from the computer body when the display panel is closed. The computer body to display panel hinge is located near the top of the computer nearest to the operator so that the open display panel is positioned as close as possible to the operator and between the operator and the rest of the computer. The keyboard 74 is fixed to the computer body and oriented to face the operator who can type by having his arms to sides and his hands to the back of the display. In order to reach the keys of the keyboard and type comfortably, there should be a minimum space 92 between the display hinge and the keyboard. On an 8″ wide display, the size to match a minimum standard key size keyboard, this space would be about 2 to 3 inches. The minimum space may contain controls not used for normal typing. The keyboard may be completely exposed when the display is shut, it may be partially exposed or, in larger models, the keyboard may be completely covered by the display when closed.

The hinge may be of the “position holding” type such as a friction hinge or ratchet hinge. It is designed to carry electricity between the panels and may also have an electrical switch to sense if the display is open. The display hinge may be designed to “snap” open just high enough for the operator's fingers to reach the pointing device on the back of the display panel. Thereafter the hinge can pivot smoothly with friction to any angle.

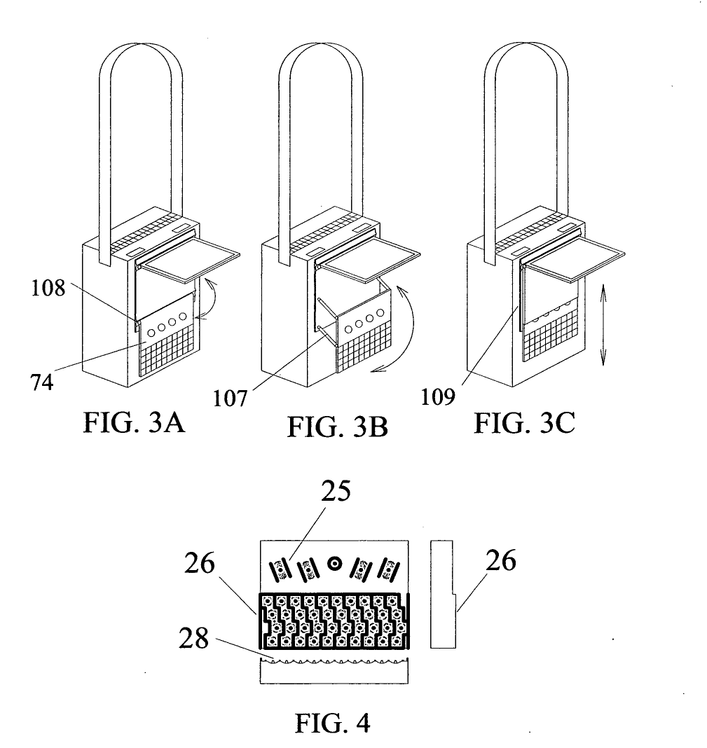

Shown in FIG. 3A to 3C, the keyboard 74 may be retractable to make the overall computer shorter. In FIG. 3A it may be located on a panel with a hinge 108 allowing it to be folded into a storage area approximately under or over the display when it is stored. In FIG. 3B the keyboard may swing open from storage with pivoting arms 107. FIG. 3C show the keyboard sliding along channels 109 out from its storage area under the display panel. The keyboard may be only partially retractable with the thumb keys remaining of the non-retracted part of the computer.

To provide full size keys for typing and still keep the computer size proportional to the average bag, a ten key wide keyboard may be included as shown in FIG. 4. The keyboard would be the width of the keys “a” to “;” on a standard QWERTY keyboard. Three or four rows may be included. Thumb keys substitute for essential keys farther to the right and left on the standard keyboard (e.g. space, return, shift, backspace, tab, change keyboard). The result is a keyboard with standard 34 inch keys and totaling 8″ or less wide. The key rows may have the standard offset or be inline. Alternative key placement may be programmed with software.

To make the keyboard easier to use without looking, tactile guides such as vertical thumb troughs 25, vertical finger ridges between the keys, depressions and/or outer edge palm ridges 26, may be included to assure finger position and to help stabilize the keyboard with the hands/palms.

To make the keyboard weatherproof, easier to clean, easier to use in the vertical position and without looking, it may have a continuous surface with depressions for each standard size key. Small actuating buttons, pegs or cones 28 would be at the bottom of each depression. These would be easier to use in the vertical position because they can be pushed down, in or up to be actuated.

If the keyboard is retractable and stores over the display, it may have structures to align the keyboard to the display panel and protect the display while stored. These structures may include edge ridges or pins, may be wedged so to form a snug fit against the display and may include spacers to keep the keys from being depressed when stored. Including the keyboard, they may form a box-like enclosure open on one side. These side structures may also touch the bag's front wall or computer hinge while closed to serve to protect the display from impact. They may be made of a material softer than the display so as to not scratch it. Pivoting keyboards may also have a general use infrared antenna located at the keyboard's distal end so it can be pointed to a receiving antenna.

In larger models, the keyboard may be split right and left in the center to make the keys more accessible from around the display.

To accommodate the use of character writing (e.g. Chinese) or handwriting recognition, an electronic write pad may be substituted for the keyboard. If the electronic write pad is retractable and stores over the display, it may have structures to align it to the display panel and protect the display while stored in the same way as the keyboard.

To maximize display area and pointing device area while more efficiently using keyboard space, a pointing device, including clickers, may be provided on the side of the display panel opposite the display. Other controls and sensors may also be provided on this side of the display panel. Instead, the display may be fitted with a touch screen.

A1 style computers may be mounted on the outside of a bag with attachments matching the bag. These attachments may include channels, clips, hanger, snaps, notches, body shaping, projecting fasteners or other means.

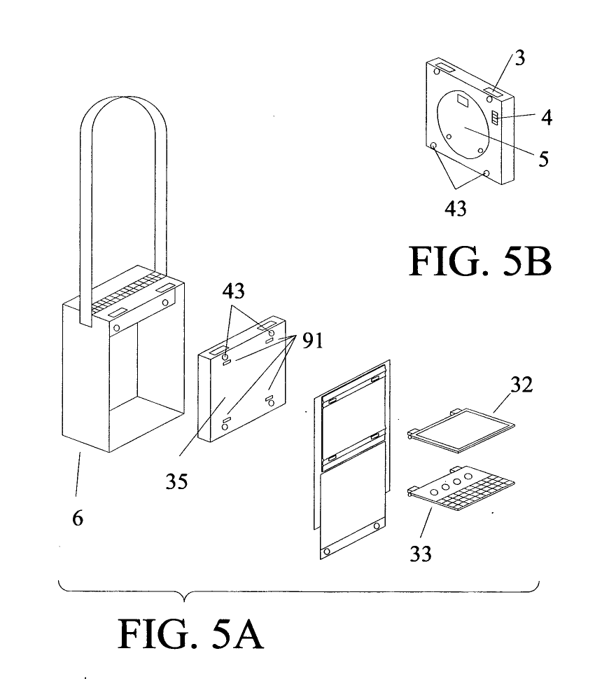

FIG. 5A shows that the computer body 35 may be mounted inside of the bag 6 with the display panel 32 and keyboard panel 33 passing to the outside front through an opening or detachable connected with plugs 91 through the bag's front wall. The display and keyboard hinge means may remain connected to either the computer body or the display and keyboard panels. The inside computer part may be shaped or have attachments 43 on any surface to match the bag's inside mounting structure. This type computer may be used with a variety of other mounting means as described in mounting means embodiments B2, B4, B5, B6 and B7.

FIG. 5B shows the side of an inside mounted computer body facing away from the bag's front wall. The side of the body panel not in contact with the bag surface may have provision for physically and electrically mounting a disk drive, batteries or other peripherals 5, may have peripheral plugs 4 (e.g. USB) and may have a removable disk drive to match the body. There may be speakers 3 near the upper edge of the computer body to provide sound and aim it upward toward the operator.

The body may have side and/or bottom bumpers for protection. The body may also have ventilation openings and interior channels to carry away heat even if cargo is against the computer body. Heat channels may exhaust via the speaker openings at the top. The body may have attachments to match those on an outside cover flap to hold it down.

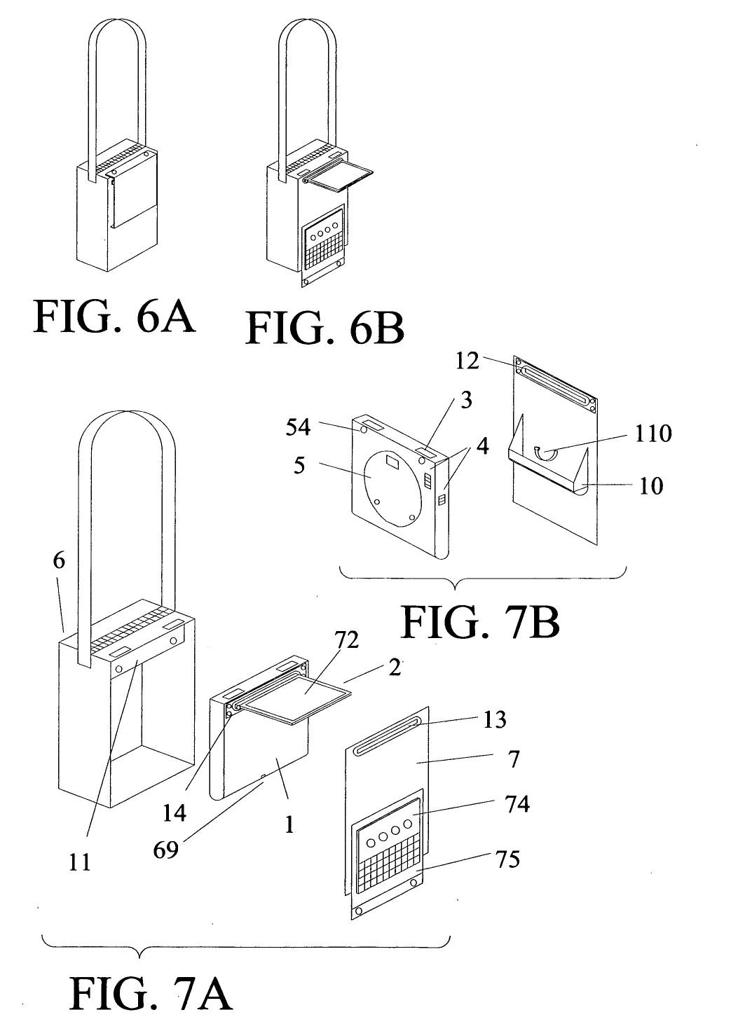

A1a embodiment series computers. If the keyboard or other manual character input device on an A1 style computer is mounted separately with a hinge means on the bag front, the input device and cover flap can be folded over the display (FIG. 6A) and may be immediately available when the cover flap is opened (FIG. 6B). This arrangement may also results in a simplified bag and computer. The input device, a relatively cheap component, may be supplied with the bag or separately.

As shown in FIG. 7A and FIG. 7B, all A1a computers have a display panel 2 and body panel 1 hinged together with the display 72 facing out on the display panel. When positioned on the bag front with the display to body hinge up nearest the operator, the display panel may be pivoted open into the line of sight of the operator. The hinge may conduct electricity between the two panels, may have a switch and may be position holding (friction, ratchet, etc). On opening, it may “pop” open just far enough for the fingers to reach the back of the display panel before continuing with normal friction. The computer may be mounted on the inside or outside of the bag's front wall.

The body may have a complimentary support structure which match the bag's mounting structure. The support structure is a combination of shaping, attachments 54, coupling 14, channels, latches or other attachment means on the body to match the bag's inside or outside mounting structure. Any of these computers may have speakers with opening facing up toward the operator. They may be supplied with appropriate connections/plugs 69 to attach to a separate keyboard or other manual character input device. Keyboard to computer communication may be by infrared or other wireless communication. Any may have a pointing device, including clickers, or other controls or sensors on the side of the display panel opposite the display. The display may be fitted with a touch screen.

There may be a separate manual character input device, such as a “bag computer keyboard” or electronic write pad, to match the computer. It mounts to the bag front below the display so that it may pivot upward to cover the closed display. To fit and protect the display it may have molded-in structures matching the display and/or adjacent bag front such as edge ridges or pins and spacers to keep the keys from contacting the display face when stored. The molded in structures and the input device together may form a box-like enclosure open on the display side.

The input device may permanently attach to the bag's cover or mounting flap via rivets, adhesive, screws, etc. The input device may be removably attached to the bag. The input device may be mounted by its back or edges to a docking port or bracket on the bag's cover or mounting flap or to a pivoting mounting frame. The input device would have the necessary attachments or shaping to match the bag mounts. The input device may be removably attached to a pivoting bag mount via one or more attachments on or near one edge of the input device so that it may pivot independently of the cover flap. The attachments may be include snaps, buttons, clips, channel, hooks, half hinge axle or bearing, buckles, sockets, Velcro, plugs or other suitable attachment means. Alternatively, the attachments may be pivotally secured to the input device body with a hinge means on one edge, the attachments matching one or more stationary fittings on the bag front. The hinge means may be an axle/bearing hinge or a flexible fabric hinge. The back side of the input device may have one or more attachments to match a cover flap so that the device and flap move together.

The electrical connection from the input device to computer or bag interior may be part of the attachment structure. Alternatively, the input device may have its own power source and equipment to broadcast information to the computer via wireless radio or infrared antenna located near the attachment edge of the input device. There may also be an infrared antenna on the outboard edge of the device for external communication. There may be a camera on the outboard edge of the input device.

To accommodate the use of character writing (e.g. Chinese) or handwriting recognition, the manual character input device may be an electronic write pad. It may have the writing surface on the distal half of the input device and the proximal half may be rigid so that the writing surface may pivot into the line of sight of the operator even if the display is partially open.

A1a1 embodiment. The computer may be mounted inside the bag with the display panel and its hinge projecting through the bag's 6 front wall 7 opening/slot 13. The hinge extends away from the computer body to permit clearance between the inside computer and outside display panel to compensate for the thickness of the bag's front wall and coupling and allow the display panel to close against the outside of the front wall. The computer body has a complimentary support structure to that of the bag to hold the bag and computer together. It may match bag components such a footing 10, flap 11, coupling 12 or other front wall attachments. The computer/bag coupling 14, in particular, may have molding, shaping or attachments as needed to align the computer to the bag's coupling 12 and strengthen the front wall opening/slot and to keep the slot from spreading under heavy bag load. This computer would normally be installed through the interior compartment access opening in the bag's top panel.

If the computer body is mounted on the inside of the bag, there may be physical and electrical provision for mounting a peripheral such as a CD, removable disk machine 5 or battery pack on the side of the computer opposite the bags front wall. There may be provided a removable disk drive with projecting fasteners specifically meant to couple with this computer. A CD drive motor may be located either in the CD machine or in the computer body. There may also be a variety of plugs (e.g. USB, power, telecom) for wire connection to other peripherals 4. These plugs may be located on the top, bottom or side edges of an inside computer. There may be speaker openings 3 facing up front the top edge of the computer body. The body panel may be provided with an electrical plug 69 on any surface to connect with the bag's plug/wiring 110 to an outside manual character input device such as a keyboard or electronic write pad 74. If input device to computer communication is by infrared, the computer's antenna may be located on the display panel side opposite the display, on the outboard edge of the display panel or on the display to body hinge. The infrared antenna may instead be located on the computer body side closest the display panel if the bag is supplied with a lens to turn and transmit the infrared light through the bag front or coupling to the computer body.

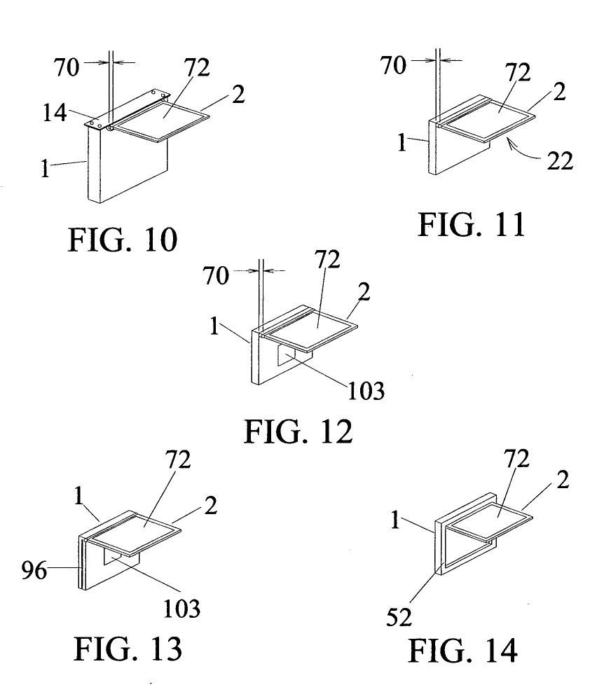

FIG. 10 illustrates that the computer/bag coupling may be shifted to the top end of the body panel so that it may be mounted in a bag designed for entry through a special mounting opening in the bag's top wall that is separate from the normal inside compartment access opening. The computer body slides in through the bag's top wall computer mounting opening from the top and the upper area of the computer body would have a computer/bag coupling 14 to secure it to the bag's computer/bag coupling in the bag's top wall. The computer's display panel 2, with the display 72 facing out, would remain outside the bag and fold down over the outside of the bag's front wall. The hinge between the two computer panels may extended away from the computer body to permit clearance 70 between the inside computer and outside display panel to compensate for the thickness of the bag's front wall and allow the display panel to close against the front wall. The computer body panel 1 may have fixtures (channels, notches, pins, latch, clips) matching the bag's computer/bag coupling and these may extend around onto the upper part of the front wall. These fixtures engage as the computer is slid down into the bag. The computer body may also have a complimentary support structure to match parts of the bag's inside mounting structure. The top edge of the computer body may include speaker openings and/or attachments to match and hold closed the bag's cover flap.

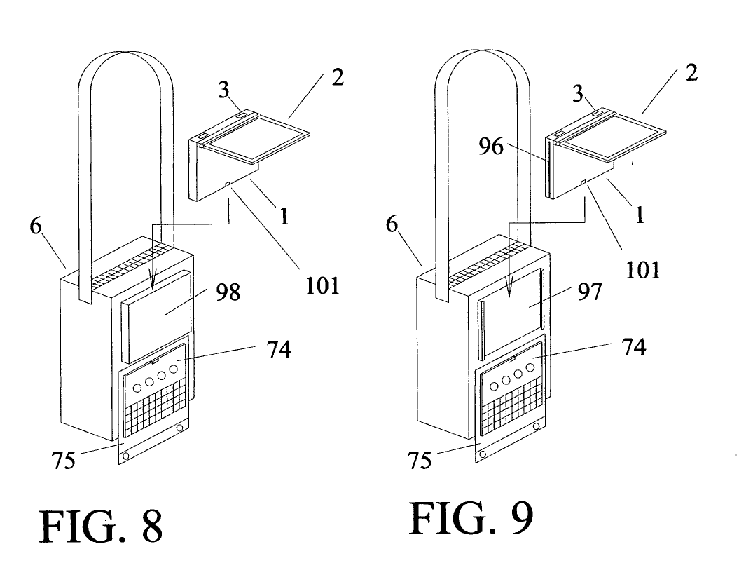

A1a2 to A1a5 outside mount. FIG. 8 and FIG. 9 show that A1a computers may be designed to mount on the outside of the bag's front wall 7. When stored, the bag's cover flap 75, with keyboard, pivots up over and covers the computing unit. The computer body panel may have complimentary support structures 96 to match a bag's outside mounting structure such as a holster 98 or docking port 97. The support structures may include attachments such as clips, notches or snaps, to hold the computer in the bag's outside mounting structure. There may be appropriate electrical keyboard and interior plugs 101 to connect to a separate manual character input device such as a keyboard 74 or electronic write pad and to the interior where there may be peripherals, batteries or other computer components.

These computers may have speaker openings facing up from the top edge of the computer body. There may be an infrared antenna to communicate with a manual character input device, inside equipment or other external equipment. The character input device antenna may be located on the display panel side opposite the display, on the outboard edge of the display panel, on the display to body hinge or on the lower portion of the computer body where the light may reach is through an opening in the bag's mounting structure.

These outside mounted computers may be used in conjunction with additional inside mounted computer equipment. The body panel may contain a CD drive or other integrated peripheral for quick access and for use off the bag.

A1a2 embodiment. In embodiment A1a2 (FIG. 11) the computer is mounted in a holster or pocket with the display 72 facing out on the outside of the holster. The computer's complimentary support structure would be a smooth and shaped computer body panel 1 to fit the holster and the hinge between the panels extends away from the computer body 70 to permit clearance between the inside computer body panel and outside display panel 2 to compensate for the thickness of the holster material and allow the display panel to close against the outside of holster's front. To provide for a pointing device, it may be mounted on the side of the display panel opposite the display 22.

A1a3 embodiment. Embodiment A1a3 (FIG. 12) is meant to be mounted inside a holster or pocket with an opening with the display on the outside of the holster. It has a body panel hinged to a display panel with the display 72 facing out when shut. The computer's complimentary support structure would be a smooth and shaped computer body 1 to fit the holster and the hinge between the panels extends away from the computer body to permit clearance between the inside computer body panel and outside display panel 70 to compensate for the thickness of the holster material and allow the display panel 2 to close against the outside of holster's front. On the body panel side facing the display panel there is a pointing device, including clickers, or other controls 103. These may be used through the opening in the holster

A1a4 embodiment. In embodiment A1a4 (FIG. 13) the computer has a display panel 2 and body panel 1 hinged together with the display 72 facing out. It is meant to be mounted to a docking port on the outside of the bag's front wall. The computer body has shaping and docking port attachments 96 complementary to the bag's docking port. There is no need for a hinge extension in this embodiment. On the body panel side facing the display panel there may be a pointing device, including clickers, or other controls 103. There may be a pointing device on the backside of the display.

A1a5 embodiment. Embodiment A1a5 (FIG. 14) has a display panel 2 and body panel 1 hinged together with the display 72 facing out. It is meant to be mounted completely inside a holster or pocket with an opening in its front. The body panel is larger than the display panel forming a computer body extension 52 all around its perimeter so that the computer will not fall out of the holster. There may be a pointing device, including clickers, on the display back.

A1b embodiment. This embodiment is the A1 style computer including the bag. The computer parts are removable and are specifically fitted to the bag. There may be electrical connection from the outside to inside the bag along with a mounting structure on the bag interior to match a computing unit, peripheral or other computer equipment. The manual character input device may pivot and may have the necessary electrical connections to connect the input device with the computing unit. The display panel may have a pointing device, including clickers, on its backside.

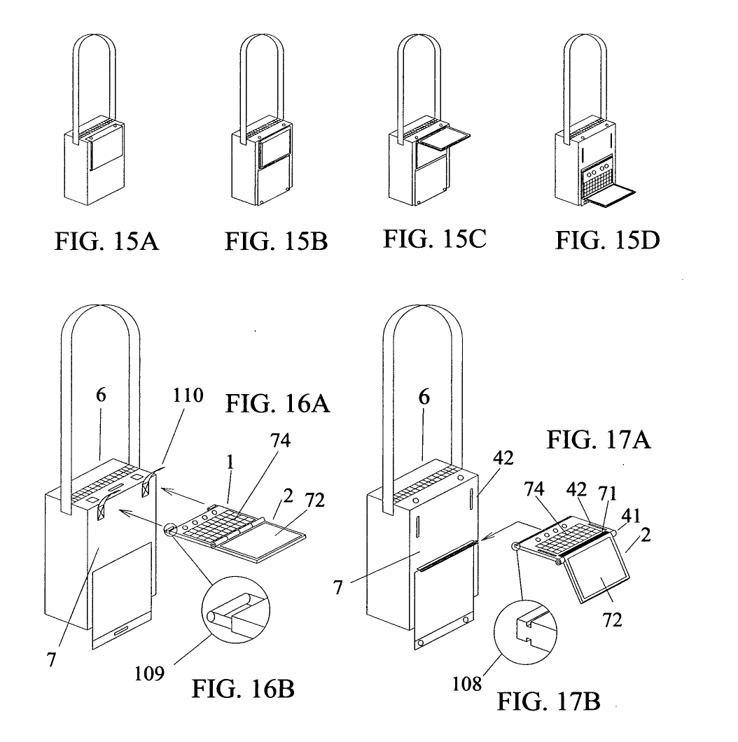

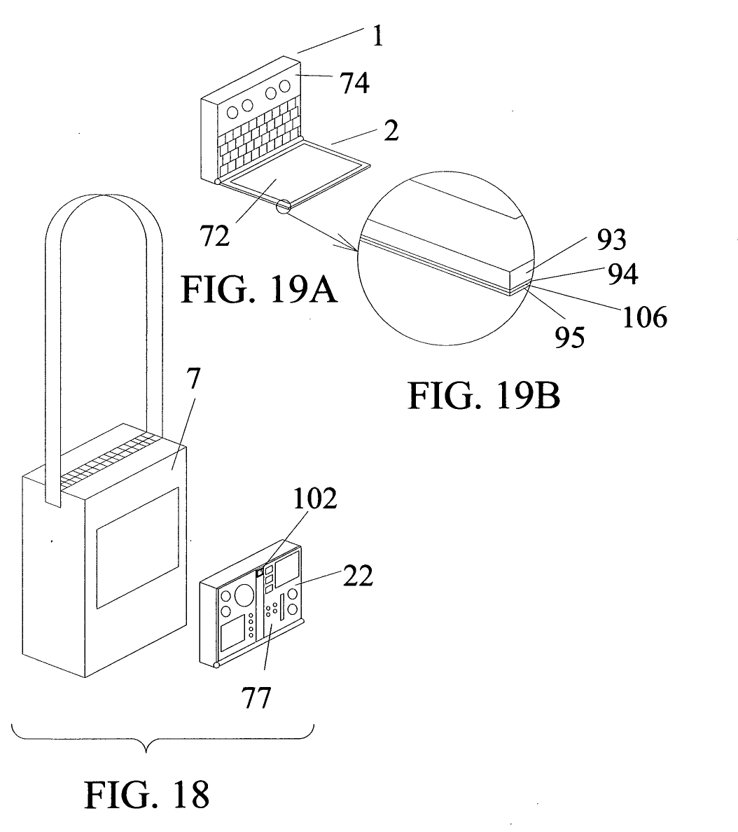

A2 embodiment. A computer with a display panel and body panel hinged together may be pivotally attached to a bag front by one edge of the body panel. A “palm top” computer with a 180 degree display to body hinge, for example, may be pivotally attached, stored and used on a bag front. This serves to maximize computer surface and allow ready use without continuously holding the computer with the hands. As shown in FIG. 15A to FIG. 15D, if the two computer body to display hinge is capable of pivoting 270 degrees or more, the computer may be uncovered from a storage position to an open position, the display opened up to a close viewing position or the body and display pivoted down to a typing position.

In FIGS. 16 and 17, the A2 embodiment of the computer meant to be operated on a bag's front wall 7 includes a display panel 2, and a body panel 1 hinged together. The body panel has a manual character input device such as a keyboard 74 or electronic write pad. The keyboard may be of the “bag computer” style and there may be a pointing device on the side of the body opposite the keyboard. The display panel has a display 72 on one side. It may have a touch screen. On the side opposite the display there may be a pointing device, including clickers, and there may also be other controls or sensors.

The computer body is pivotally secured to the bag front with attachments located on the body's attachment edge which is the edge opposite the body to display hinge. There may be a single attachment along the body's attachment edge. The attachment may plug-in as with a post and clip attachment or its complementary fixture. The post and clip attachment has one or more pins or flat bars to align and strengthen the connection while one or more clips hold the two parts together. Examples include side release buckles and common suitcase clasps. Alternatively, the attachment may be Velcro. The attachment may be designed to engage laterally using a channel 108 or lateral hooks. The attachment may be a half hinge such as a bearing or an axle connected to the computer by one or both ends. The half hinge may be a bearing of flexible material and split lengthways so the axle can snap into place.

There may be two attachments, one near the right and one near the left sides of the computer's attachment edge. Examples include snaps, buttons, buckles, side release buckles, hooks, or other attachment means. The two right and left attachments may be a footing and retainer attachment. The footing and retainer attachment has a footing such as a pin or socket matching the bag on one corner of the computer's attachment edge and a retainer such as a clip or complimentary notch to hold the other corner of the computer's attachment edge to the bag. Instead, the attachments may be half hinges such as bearings or two axles 109 connected to the computer by one or both ends. The computer's axles may be secured to the bag with bag straps 110 threaded through them and allowing the computer to pivot horizontally. The half hinges may be bearings of flexible material and split lengthways so the axles can snap into place. The half hinges may be short axles projecting from the right and left corners of the computer's attachment edge. The attachments may be molded into the computer body or separate attachments may be secured to it.

The attachment may be pivotally secured to the computer body using one or more hinge means near the body's attachment edge. There may be one or more axle and bearing assemblies secured to the computer edge and including an attachment such as a hanger blade, double hanger bars, bracket, pins, sockets or other attachment means designed to match stationary fixtures on the bag front.

The hinge means may be flexible fabric clamped or crimped to the computer body and having one or more attachments on the fabric which match the bag. There may be one attachment such as a zipper or Velcro. Instead, there may be two or more attachments such as buttons, button holes, snaps, side release buckles or other fasteners. The flexible fabric may be divided in two forming tabs or buckle straps near the right and left sides of the computer body edge. Attachments may include snaps, buttons, button holes, buckles, buckle holes, Velcro or other attachment means.

However attached to the bag, a hinge means on either the body or bag will allow the body to pivot 90 degrees or more on a horizontal axis on the bag front.

Electrical connection/plug may be supplied on the body panel near the attachment edge to connect through the attachment and front wall to the bag's interior.

The display to body panel hinge has an electrical connection between the panels and may have a switch to sense whether the panels are open. The hinge may be of the “position holding” type such as a friction hinge or ratchet hinge that can hold any angle.

FIG. 17A shows that the display and body panels may be connected with a single axle hinge means 41 capable of rotating at least 270 degrees. The large rotation is achieved using cut-outs 71 near the hinge on one or both panels to allow clearance. The single axle may be divided into right and left parts while still being on the same axis. The combination of the 270 degree rotation hinge connecting the two panels and the hinge connecting them with the bag front allows the display panel to be perpendicular to the operator's line of sight both when the computer is in the “up” position (FIG. 15C) and in the “down” position (FIG. 15D).

When stored, the display to body panel hinge may be toward the top of the bag with the display and keyboard on the outside of the assembly facing away from each other. Instead, the display to body panel hinge may be toward the center or bottom of the bag when stored with the display and keyboard on the inside of the assembly facing toward each other.

If the body to bag hinge means cannot hold an angular position itself, up position attachments 42, such as hooks, magnets or other attachments easily connected and disconnected, may be located on the body panel and match ones on the bag's front wall in order to hold the computer in the “up” position without using the hands.

The body may contain the computing unit so that the display/body assembly is a self-contained computer.

Alternatively, the body panel attachments may include electrical connection and be designed to physically and electrically connect the display/body assembly to a separate computer component with the computing unit. The connection between the body/display assembly and computer component can pivot 90 degrees or more. This arrangement allows the pivoting display/body assembly to be as thin and light as possible while the majority of the computing equipment is located in the stationary computer component. The separate computer component with the computing unit may take the form of a panel with a size and shape and attachments to be removably secured to the outside front surface of a bag. The attachment between the body/display assembly and computer component may be permanent or removable. The separate computer component with the computing unit may take the form of a panel with a size and shape and attachments to be removably secured to the inside surface of the bag front. The attachment between the body/display assembly and computer component may be permanent or removable. The separate computer component with the computing unit may take the form of a bag with an attachment on its front wall which matches the body, allows the body to pivot on the bag front and allows the body/display unit to be removed from the bag. The bag, in turn may have a computing unit which is removable.

If the computer component with the computing unit is a panel mounted on the inside of the bag, it may have provision for mounting a disk drive, batteries, peripherals or have peripheral plugs (e.g. USB) on the sides not facing the bag front. There may be a removable disk drive to match the mounts. The computer component panel may have speakers mounted on the top edge facing up toward the operator and it may be shaped or have attachments on any surface to match the bag's inside mounting structure.

A2a embodiment. This embodiment is the A2 style computer including the bag. A two panel body/display assembly is pivotally secured to the bag front with the computing unit either in the body/display assembly or mounted elsewhere in the bag. Most interior bag space is left open for general cargo. The computer parts are removable and are specifically fitted to the bag. There may be an electrical connection 920 from the outside computer equipment to the inside of the bag and it may include plugs to facilitate the removal of computer equipment. There may be a computer equipment mounting structure on the inside of the bag and this matches a computer unit, peripheral or other computer equipment mounted to the bag. The display panel may have a pointing device, including clickers, on its backside.

A3 embodiment. This embodiment of the bag computer, shown in FIG. 8 and FIG. 9, provides for a computer for mounting on a bag front 7 comprising a body 1 with computing unit pivotally attached to an input/output panel 2 with a display 72 on one side and a touchpad 22 on the opposite side. The hinge means connecting the body and input/output panel also provides electrical connection, may have a switch and may hold any position using a friction or ratchet mechanism. The input/output panel may attach anywhere on the body surface which allows the display to be pivoted into the line of sight of the operator. No computer need be included in the input/output panel. When the input/output panel and body are closed together, the display may face in toward the body or out away from the body panel.

This arrangement serves to maximize display area, allows more touchpad area than if it were on the keyboard, allows the touchpad to be used with one or two hands, allows other touchpad functions (e.g. joystick), allows the touchpad to be used even if the keyboard panel is not available, provides lighter display panel construction, allows for more extensive computing equipment in the separate body and puts the operators 940 hands in a more natural position for bag computer use. Compared to a touch screen, this arrangement allows more precise pointing without a stylus, keeps the display cleaner and allows the use of a protective film scratch protector.

The touchpad 22 may be one large touchpad with multi position sensing capability. A sub-processor may be included. Alternatively, if the type of touchpad used is not capable of multi position sensing, there may be an array of smaller touch pads adjacent to each other.

The touchpad(s) may be programmed to allow the operator to make a custom array of touch tools such as touch pad, touch joystick, touch buttons, touch slides, etc. Touch functions buttons may be included to quickly change the touchpad arrangement to match programming changes or to compensate for a change in position of the operator (e.g. standing vs sitting). Other function may include initiating programs or changing the keyboard configuration.

The touchpad area may also be supplied with variable and replaceable finger guides 77 which match the programmed areas on the touch pad(s). These tactile templates may have a continuous thin surface or may have holes and may have slots, bumps, ridges, etc for the purpose of guiding the fingers to the desired controls on the back of the display. These may be attached with removable adhesive or may have matching attachments, such as clips, to hold them to the touchpad(s).

The touchpad side of the display panel may have an IR antenna 102 for communication with a separate keyboard or with external computing unit such as a desk top computer or computer peripheral. Other sensors may also be provided on this side of the display panel.

The input/output panel may be constructed of three fused layers. They include: A clear rigid support panel layer 93 with the attachment to match the body such as a hinge with attachment to match the body, one half of a hinge to match a half hinge on the body, flexible fabric or a plug, channel or other attachment to match a hinge on the body. The attachment may be molded into the support panel or connected separately; A display array layer 94 with necessary conductors; A touchpad layer 95 which will vary depending on the technology used. Its conductors would be included in this layer. There may be an insulation layer 106 separating the display array and touch pads. It may direct light through the clear layer via reflection or absorption. No computing unit is needed in this panel.

The body includes a computing unit. It may have a manual character input device such as a keyboard 74 or electronic write pad. If the display is removable, the body would have the necessary matching attachments, half hinge or hinge with attachments to match the display. The body may be panel-like and have attachments or shaping anywhere on the body to match complimentary fittings on the inside or outside of the bags front wall. The body may take the form of a bag with the computing unit fitted to it. The computing equipment in such a bag may be removable.

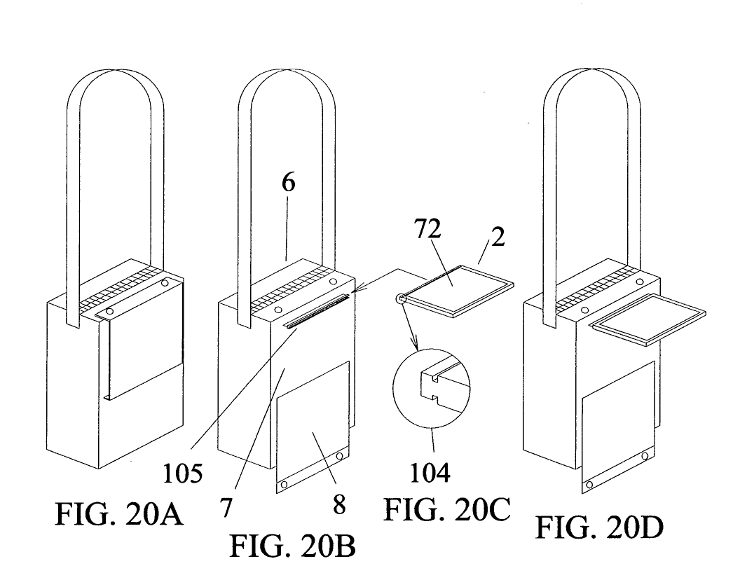

A6 embodiment. This embodiment, shown in FIG. 20, provides for a computer combined with a bag 6 which has a display panel 2 pivotally attached to the outside of the front wall 7 of the bag. The display 72 is located on the upper surface of the display panel when the panel is pivoted perpendicular to the bag front. The computing unit may be located on the bag's outside front surface, bag interior or in the display 985 panel. The display panel is attached to the bag front using a hinge means such as short flexible fabric flap 105, axle/bearing hinge, two half hinges or other means which allows the display to swing 90 degrees or more on a horizontal axis. Hence, the display may be stored flat (FIG. 20A) against the bag front or pivoted into the line of sight on the operator (FIG. 20D) for operation. The bag is designed to have storage 990 space for general cargo inside the bag even when the computer equipment is mounted.

The computer and/or display panel may be removably secured to the bag.

The display panel may be removably attached by the display panel edge near the bottom of the display so it may pivot around that edge. The display panel attachment may be stationary and match a complimentary attachment on a hinge 995 means on the bag front. The display panel attachments may include channel 104, lateral hooks, pins or sockets, axle, snaps, clips, buttons, button holes, buckles, bracket, docking port, buckle straps, side release buckles, zipper, Velcro or other attachment means. Alternatively, the hinge means may be located on the display panel with the hinge having an attachment which removably secures it to stationary 1000 attachments on the bag front. Instead, the display and the bag may have matching half hinges.

The display panel may be attached by its back or several edges to a mounting frame or mounting structure on a panel or cover flap pivotally secured to the bag front. There would be matching attachment parts on the display panel and mounting structure.

The display panel may be attached to the bag front with a second panel pivotally secured to the display panel. The second panel, such as a computer body, hanger blade or bracket, may be removably secured to the bag front with a docking port, pocket, bracket or other mounting structure located on the bag's front wall. This second panel may mount on the outside of the bag's front wall or may mount on the inside of the front wall with an opening to allow the display panel to pass to the outside. The second panel may have computing equipment in it or not.

The display panel may contain the computer unit and may included batteries to make it a self-contained computer. On the side of the display panel with the display there may also be input/output devices such as a pointing device, touch screen, keyboard, electronic write pad, speaker, microphone, etc. On the display panel side opposite the display there may be a pointing device and other controls. The edge opposite the attachment to the bag may have a camera and/or an IR antenna for external communication.

The display panel may have electrical connection through its attachment, if present, hinge means and bag front wall to the bag's interior. If a flexible fabric hinge means is used for display panel mounting, wiring may pass between two fabric layers to attachments fixed to its distal edge so that the electrical connection may be made without more complicated axle/bearing connections. The bag may have an inside mounting structure on any surface which matches and holds a computer unit, further computer equipment or peripherals and connect them to the outside display panel.

There may be a cover flap 8 and this may attach near the middle of the bag's front and open by falling down. Attachments for holding the cover flap in the closed position may be located on the bag's front or top wall.

A6a embodiment. The advantages of a bag computer can also be realized with a less expensive single panel computer or a PDA.

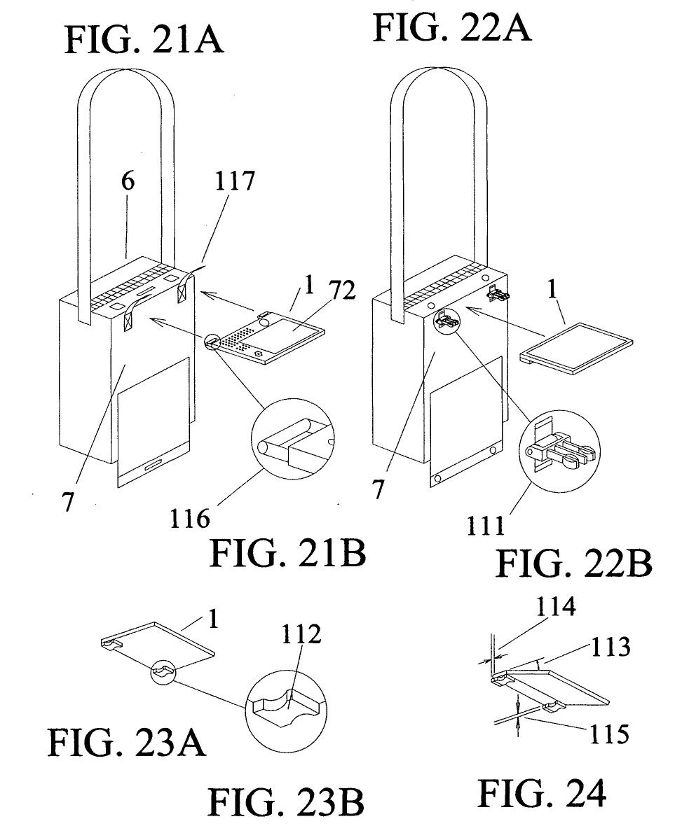

The A6a embodiment. FIG. 21 to FIG. 24 is a self-contained computer with a body 1 of approximately rectangular shape and a display 72 on one surface. There is an attachment along the body edge near the bottom of the display, also called the attachment edge. This allows the computer to be mounted pivotally to the front of a bag 7 using straps 117, pivoting clips 111, mechanical hinge or other hinge means on the bag or on the computer.

There may be a single attachment along the attachment edge. The attachment may plug-in as with a post and clip attachment or its complementary fixture. The post and clip attachment has one or more pins or flat bars to align and strengthen the connection while one or more clips hold the two parts together. Examples include side release buckles and common suitcase clasps. Alternatively, the attachment may be Velcro. The attachment may be designed to engage laterally using a channel or lateral hooks. The attachment may be a half hinge such as a bearing or an axle connected to the computer by one or both ends. The half hinge may be a bearing of flexible material and split lengthways so the axle can snap into place.

There may be two attachments, one near the right and one near the left sides of the computer's attachment edge. Examples include snaps, buttons, buckles, hooks, clips, side release buckles 112, or other attachment means. The two right and left attachments may be a footing and retainer attachment. The footing and retainer attachment has a footing such as a pin or socket matching the bag on one corner of the computer's attachment edge and a retainer such as a clip or complimentary notch to hold the other corner of the computer's attachment edge to the bag. Instead, the attachments may be half hinges such as bearings or two axles 116 connected to the computer by one or both ends. The computer's axles may be secured to the bag with bag straps 117 threaded through them and allowing the computer to pivot horizontally. The half hinges may be bearings of flexible material and split lengthways so the axles can snap into place. The half hinges may be short axles projecting from the right and left corners of the computer's attachment edge. The attachments may be molded into the computer body or separate attachments may be secured to it.

The attachment may be pivotally secured to the computer body using one or more hinge means near the attachment edge. There may be one or more axle and bearing assemblies secured to the computer edge and including an attachment such as a hanger blade, double hanger bars, bracket, pins, sockets or other attachment means designed to match stationary fixtures on the bag front.

The hinge means may be flexible fabric clamped or crimped to the computer body and having one or more attachments on the fabric which match the bag. There may be one attachment such as a zipper or Velcro. Instead, there may be two or more attachments such as buttons, button holes, snaps, side release buckles or other fasteners.

The flexible fabric may be divided in two forming tabs or buckle straps near the right and left sides of the computer attachment edge. Attachments may include snaps, buttons, button holes, buckles, buckle holes, Velcro or other attachment means.

The computer may be tapered to be thinner and lighter at the distal end and may have heavier components, such as batteries, near the bag. The computer body and attachments may be shaped to allow the computer to lay flat against the bag even if there is some bag bulge caused by cargo in the bag. For example, the attachment length 114 can compensate for bag bulge when the computer is in viewing position and attachment elevation 115 can compensate for bag bulge when the computer is stored down. Body angle 113 can allow the computer to touch the bag at the far top and far bottom of the body so it will stay against the bag when stored. The shaping of the computer body can be molded into rounded curves, especially on the side opposite the display, to fit the bag best and may be arranged to protect any controls on the back side of the computer.

A6a computers have a display 72 on the side facing toward the operator and this may have a touch screen. There may also be a small keyboard, electronic write pad, pointing device, scroll buttons or bar, speaker, microphone or other controls on this side. On the side of the computer opposite the display there may be a pointing device or other controls. The computer would have a power source such as batteries. There may be television, music player, radio, telecommunications and/or GPS. There may be a camera and/or an infrared antenna for external communication on the computer edge opposite the attachments. There may be additional plugs for data transfer, charging, earphones, etc.

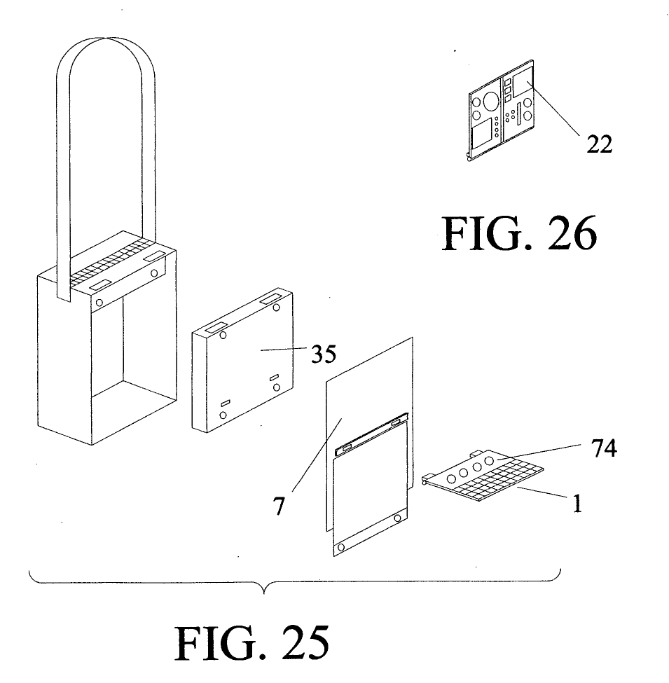

A7 embodiment. The A7 embodiment of the bag computer FIG. 25 and FIG. 26 is meant to be operated with a head mounted display (HMD). It may have one panel or two panels hinged together.

One panel would consist of a computer body panel 1 with a keyboard 74 on one side of the panel and a pointing device 22 on the other. The pointing device may be a touch pad and this may be programmable. Other controls and sensors may be provided on this side of the body panel.

The body panel, when pivotally secured to the bag front 7, can be used hinged up for touchpad use only, hinged down for keyboard use only or positioned semi perpendicular to the bag front where the panel can be held and the touchpad operated. The HMD connects separately and the computer has no display of its own. The body may have the appropriate plug for the HMD or wireless communication may be provided for the HMD. There may be IR antenna on the distal edge of the body panel for external communication. The computing device may contain Telecom, GPS, etc.

The body edge closest to the keyboard row having the V, B and N key row has attachments to pivotally secure the body to the bag front. The attachments may be detachable and match complimentary fitting on the bag front. There may be one or more stationary attachments on the body matching a pivoting attachment on the bag front. The body attachments may include snaps, buttons, clips, channel, hooks, axle, buckles, sockets, Velcro, plugs or other suitable attachment means. The attachments may be pivotally secured to the body with a hinge means, the attachments matching a stationary fitting on the bag front. The hinge means may be an axle/bearing hinge or a flexible fabric hinge. The hinge means may be half hinges such as a gudgeon, pin, or strap bearings.

Electrical connection to the bag may be provided through the attachment and this may lead to further computer equipment mounted inside the bag.

The computer may have attachments on keyboard side of the body panel to match ones on the outside surface of the bag's front wall in order to hold it in the “up” position flat against the bag front.

The computer body may contain the computing unit. Alternatively, the computer body may be physically and electrically connected with the attachments to a second computer part 35 containing the computing unit. The second computer part may be mounted on the outside or inside of the bag front. The two panels may be removably secured to each other and the hinge may be on either the body panel or the second computer part. The second computer part may have a complimentary support structure to match the bag.

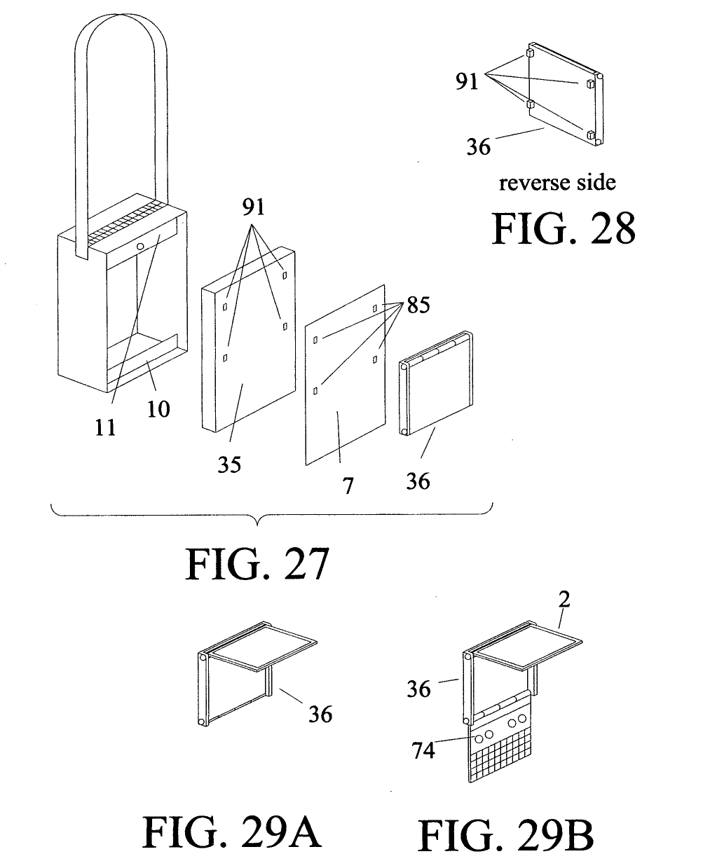

B2 embodiment. As shown in FIG. 27 to FIG. 29, this embodiment the bag computer is divided into at least two parts, one on the inside 35 of the bag's front wall 7 and the other(s), display panel and/or keyboard panel 36, for example, on the outside of the bag's front wall. The inside and outside parts have complimentary fittings 91 which connect through a pattern of holes 85 in the bag's front wall and hold the computer to the bag's front wall. These fittings may also carry the necessary wiring for electrical connection between the inside and outside parts. The two parts may be shaped and connect with allowance between the two parts for the bag in terms of its material thickness, hole trim and mounting plates (if present) to assist in making the computer fit and hold to the bags front wall. The two parts may be connected with adjustable plugs to adjust to any bag material thickness and there may be a seal between the two parts. The computer may have release buttons/twisters/slides/etc to disengage the inside and outside parts.

The computer may be divided so that the inside part serves as 1) a backing plate or, 2) contains a portion of the computing equipment or 3) contains most of the computing equipment with only input/output devices such as display 2, pointing device and/or keyboard 74 on the outside.

A mounting structure such as a footing 10 and/or flap 11 either inside or outside the bag's front wall may assist in holding the computer to the bag and the computer may have a complimentary support structure to match this mounting structure. The sides of the computer parts facing the bag wall may be molded to fit the bag and hold it to the bag front and may include connecting plugs/sockets, depressions to fit grommets, attachments to match those comprising a mounting structure on the inside or outside of the bag's front wall, ridges, spikes, bumps, etc. designed to grip the bag material, shaped areas to match a mounting plate on the inside or outside of the bag's front wall.

This arrangement serves to 1) simplify the bag's construction by eliminating rigid bag panels, wires and plugs, 2) keep the outside parts, those used by the operator to communicate with the computer, as small and light as possible, 3) provide protection for the computer and its plugs by having them inside the bag, 4) move the center of weight of the computer toward the bag center, 5) allow the attachment of computer peripherals directly to the computer inside the bag, 6) the computer serves as a backing plate for the outside components so that no rigid panel is needed in the bag.

The sides of the inside part not in contact with the bag front may have provision for physically and electrically mounting a disk drive, batteries or other peripherals, may have peripheral plugs (e.g. USB) and may have a removable disk drive to match the body. It may have speakers mounted on the top edge facing up toward the operator.

A bag may be provided to match the computer, its attachments and shaping.

B4 embodiment. This embodiment of the bag computer has a computer with a body panel and display panel hinged together. The body would have attachments on the same side as the display panel when shut in order to match the bag's mounting structure.

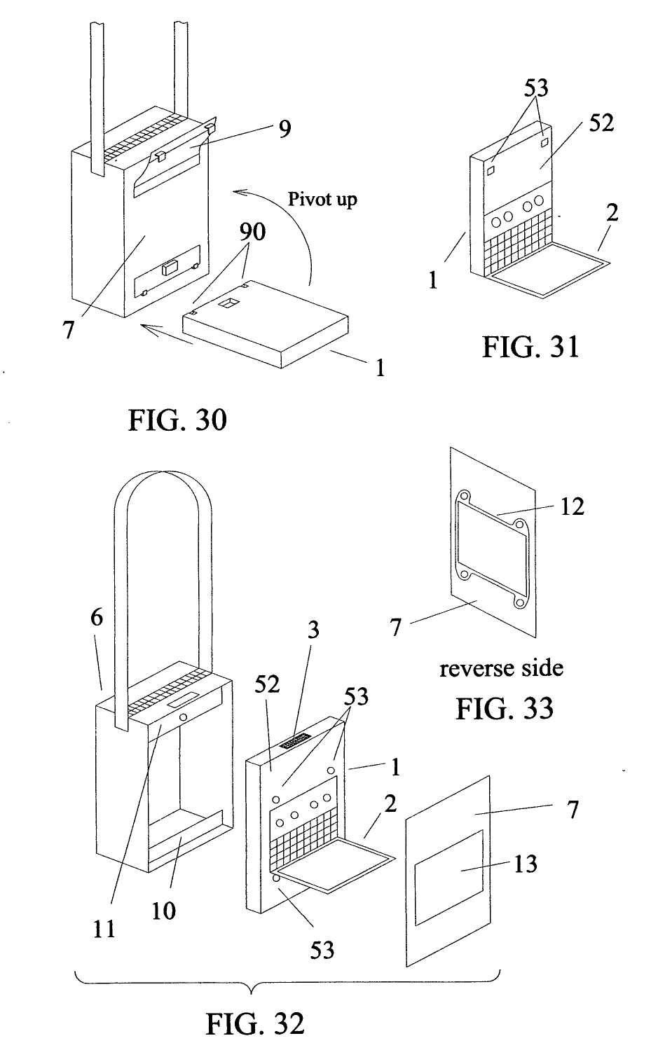

If the computer is mounted on the outside of the bag's front wall 7, as shown in FIG. 30 and FIG. 31, there may be attachments 53 on an extension 52 of the computer body 1 on the same side of the computer as the display panel 2. This positioning allows for easy access to fasteners for quick removal of the computer from the bag. These attachments would match attachments located on a mounting flap 9 attached to the bag's front wall. The attachment may match hooks, clips, snaps or other attachments found on the flap. Additional attachments 90 may be located on other parts of the computer body to complete the total mounting system.

For a computer 1 mounted inside a bag 6 with an opening 13 in the front wall 7, shown in FIG. 32 and FIG. 33, the attachments 53 would be on the same side of the body panel as the display panel 2 when shut. The attachments may be located under the display or on extensions 52 of the body beyond the display panel. This arrangement allows the computer to be attached to the inside surface of the bag's front wall so that the display panel can still open to the outside through the bag opening. These attachments serve to both hold and align the computer to the front wall. The attachments may project out or be inset, may include molded features such as ridges or depressions and may be part of a larger more complex coupling matching a bag coupling 12 surrounding the bag's opening.

These attachments may be augmented by other attachments on any surface of the computer body which match additional members of the bag's mounting structure such as a footing 10 or flap 11.

If the body panel is mounted on the inside of the bag, the sides not in contact with the bag front may have provision for mounting a disk drive, batteries or other peripherals, may have peripheral plugs (e.g. USB) and may have a removable disk drive to match the body. It may have speakers 3 mounted on the top edge facing up toward the operator.

A bag may be provided to match the computer, its attachments and shaping.

B5 embodiment. Notebook computers attaching to docking ports may have recessed fasteners with the projecting fasteners located on the docking port. This allows the computer to set flat on a table when not in the docking port. Bag mounted computers, however, might be too thin to accept attachments from the bag. A computer bag may be built with a rigid front and an opening or a pattern of holes to receiving attachments projecting out from the bag computer's back.

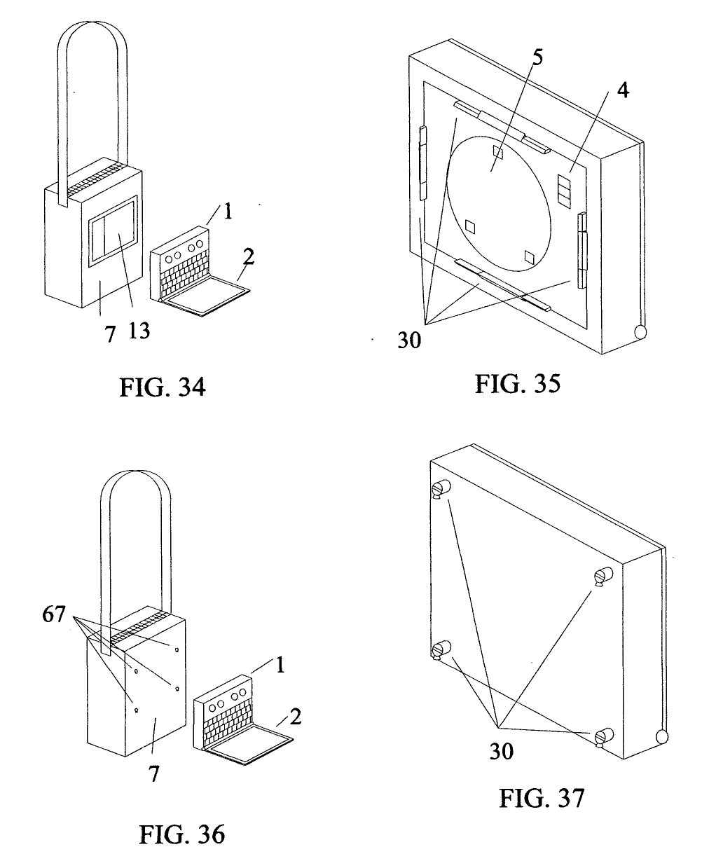

The B5 embodiment, shown in FIG. 34 to FIG. 37, provides for a bag mounted computer with a body 1 hinged to a fold out display panel 2 with projecting fasteners 30 coming out from the body on the side opposite the display for attachment to the bag front 7. The fasteners may be clips, twist fittings or other attachments designed to match edges of a bag front wall opening 13, front wall attachment holes 67 or other complimentary fittings on the bag front. The fasteners may be associated with alignment ridges or pins to help secure the computer to the bag's front wall.

On the side of the computer body opposite the display there may be provision for mounting a disk drive 5, peripheral plugs 4 (e.g. USB) or batteries. There may a removable disk drive to match the body.

A bag may be provided to match the computer, its attachments and shaping.

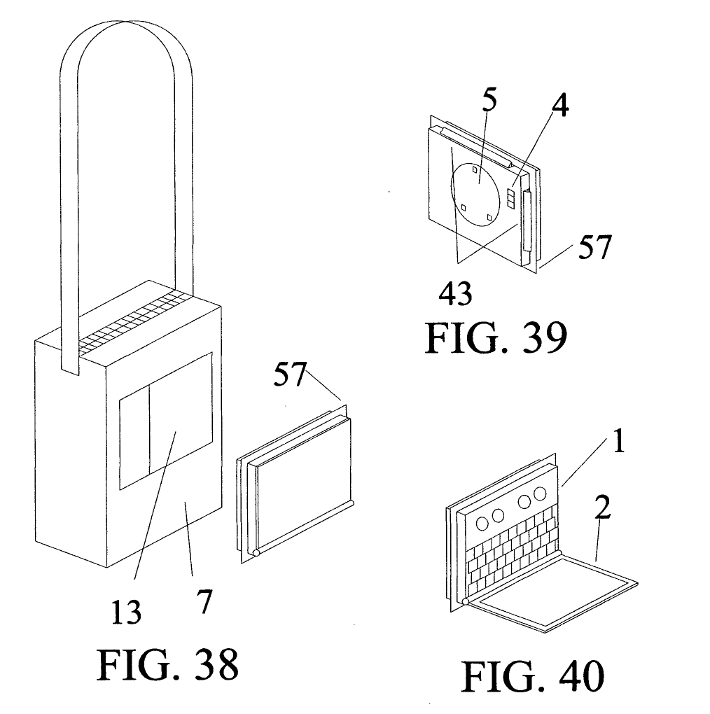

B6 embodiment. A bag computer may mount to a bag front opening using a flange around the perimeter of the body panel. In this embodiment of the bag computer (FIG. 38 to FIG. 39) there is a body 1 hinged to a fold out display panel 2 and a mounting flange 57 around the perimeter of the body to mate with the bag's front wall 7 and its opening 13. The flange may be anywhere along the perimeter or flush with the display side surface of the computer. There may be attachments 43, such as clips, built into the computer to match the bag opening's edges. Alternatively, there may be edges, grooves or notches to match clips attached to the bag.

On the side of the computer body opposite the display there may be provision for mounting a disk drive, batteries or other peripherals 5, may have peripheral plugs 4 (for example USB) and may have a removable disk drive to match the body.

A bag may be provided to match the computer, its attachments and shaping.

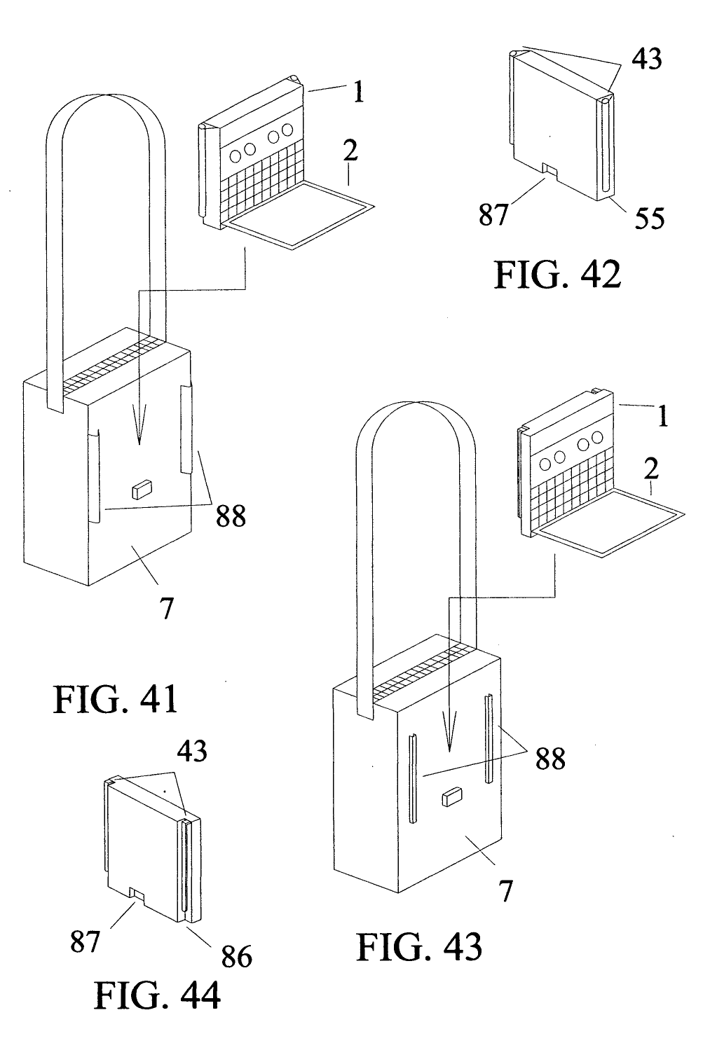

B7 embodiment. This bag computer embodiment, shown in FIG. 41 to FIG. 44, is for a computer with body 1 hinged to a display panel 2 so that it pivots out into the line of sight of the operator. To mount the computer on the bag front wall 7 hangers such as bars 43 or channels are located near the right and left extremes of the computer body near its back where it attaches to the bag. Hanger bars may attach near the top of the computer, extend down and may be round, rectangular or flat bars. Channels may attach to the body sides or back and may be molded into the body. To make sure that the computer is flush with the bag front these hangers may be on the right and left edges of the computer 55 or on the back side inset 86 into the computer body. These match hanger attachments 88 on the bag front.

There may be an electrical connection/plug 87 to the interior of the bag and this may be located on the bottom edge of the computer or at the bottom end of one of the hangers.

There may be a matching bag with hanger sockets to match the hanger bars on the computer.

The preferred embodiments of the invention described herein are exemplary and numerous modifications, variations, and rearrangements can be readily envisioned to achieve an equivalent result, all of which are intended to be embraced within the scope of the appended claims.

I claim:

1. A computer comprising:
a body with a support structure;
a display panel;
a hinge connected the body and the display panel wherein the hinge holds the display facing out when closed; and
a bag with mounting structure to match the body support structure and removably hold the body to the bag.

2. The computer of claim 1, wherein the bag is removable from said computer.

3. The computer of claim 1, wherein the display panel comprises a back side and a front side, wherein the front side is viewable display, and the back side further comprises a pointing device.

4. The computer of claim 1, further comprising an electrical connection from the body through the bag front wall to the interior of the bag.

5. A computer comprising:
a body
a display panel; and
a hinge connected the body and the display panel wherein the hinge holds the display facing out when closed and wherein the hinge is extended to permit clearance between computer body and display panel.

6. The computer of claim 5, wherein the display panel comprises a back side and a front side, wherein the front side is viewable display, and the back side further comprises a pointing device.

7. A computer comprising:
a bag having a front wall
a display panel, wherein the display panel is pivotally attached to the bag near a top of the bag front wall wherein the display faces outward when closed; and
an input device, wherein the input device is secured to the outside of the front wall near a bottom of the front wall.

8. The computer of claim 7, wherein the display panel is removable.

9. The computer of claim 7, wherein the input device is removable.

10. The computer of claim 7, wherein the input device pivotally secured to the bag front wall.

11. The computer of claim 7, wherein the display panel comprises a back side and a front side, wherein the front side is viewable display, and the back side further comprises a pointing device.

12. The computer of claim 7, further comprising an electrical connection from the body through the bag front wall to the interior of the bag.

13. A computer comprising:
a bag having a front wall
a display panel, wherein the display panel is pivotally attached to the bag near a top of the bag front wall wherein the display faces outward when closed.

14. The computer of claim 13, wherein the display panel is removable.

15. The computer of claim xx, wherein the input device is removable xx. The computer of claim 13, wherein the display panel comprises a back side and a front side, wherein the front side is viewable display, and the back side further comprises a pointing device.

16. The computer of claim 13, further comprising an electrical connection from the body through the bag front wall to the interior of the bag.

17. A computer comprising:
a bag having a front wall
a display panel, wherein the display panel is pivotally attached to the bag near a top of the bag front wall wherein the display faces outward when closed; and
a pivoting cover attached near a middle of the front wall wherein the pivoting cover may pivot to cover the display panel.

18. The computer of claim 17, wherein the display panel is removable.

19. The computer of claim 17, wherein the display panel comprises a back side and a front side, wherein the front side is viewable display, and the back side further comprises a pointing device.

20. The computer of claim 17, further comprising an electrical connection from the body through the bag front wall to the interior of the bag.
